(19) United States
(12) Patent Application Publication
(10) Pub. No.: US 2015/0381296 A1
(43) Pub. Date: Dec. 31, 2015

(54) WIRELESS TRANSMISSION OF SOUND SIGNALS TO MULTIPLE DISCRETE SPEAKERS

(71) Applicants: Cheng Yih Jenq, Piscataway, NJ (US); Ming-Jye Sheng, Basking Ridge, NJ (US)

(72) Inventors: Cheng Yih Jenq, Piscataway, NJ (US); Ming-Jye Sheng, Basking Ridge, NJ (US)

(21) Appl. No.: 14/750,962

(22) Filed: Jun. 25, 2015

Related U.S. Application Data
(60) Provisional application No. 62/016,726, filed on Jun. 25, 2014.

(51) Int. Cl. H04H 20/88; H04R 5/04; H04S 1/00; H04R 3/12

(52) U.S. Cl. CPC H04H 20/88; H04R 3/12; H04R 5/04; H04S 1/007

(57) ABSTRACT

Systems and methods for wireless communication of sound signals to multiple discrete speakers to establish a rich wireless audio system for use in multiple environments is provided. In one embodiment of the present disclosure, a computing device receives a multiplexed audio signal containing multiple audio channels and demultiplexes the signal and transmits separate demultiplexed signals to wireless speakers, where the separate wireless signals are played by the individual wireless speakers. In another embodiment of the present disclosure, a computing device receives a multiplexed audio signal containing a left and a right audio signal and demultiplexes the signal and uses the left and right audio signals to create a bass signal for use with a three way sound system. In yet another embodiment of the present disclosure, a wireless speaker is configured to listen and intercept a wirelessly transmitted multiplex signal and demultiplex the signal to play a predetermined audio channel.

### PRIORITY

This application claims priority to U.S. Provisional Patent Application No. 62/016,726 filed Jun. 25, 2014, entitled “Wireless Transmission of sound signals to multiple discrete speakers”, the contents of which are hereby incorporated by reference in its entirety.

### BACKGROUND

1. Field

The present disclosure relates generally to audio systems, and more particularly, to wireless, multi-channel audio systems.

2. Description of the Related Art

A multiplexed audio stream that contains two or more channels of audio data can be transmitted from a variety of computers through either WiFi™ or Bluetooth™ to a speaker unit that contains a transceiver. However, the speaker unit, if it is designed to replay the multi channels of audio signal, for instance, the right channel and left channel audio signals, the speaker unit must use two speaker subunits, that is, a right speaker unit and a left speaker unit, and that. Additionally, the speaker unit it must cable or wire connect the two speaker subunits.

### SUMMARY

The present disclosure provides for systems and methods for wireless transmission of sound signals to multiple discrete speakers to establish a rich wireless audio system for use in multiple environments. The system and methods of the present disclosure provide for a computing device that demultiplexes a multiplexed multichannel audio signal and transmits the demultiplexed audio signals to multiple discrete wireless speakers. Furthermore, the systems and methods of the present disclosure provide for the generation of a bass signal from a multiplexed audio signal containing only a left audio channel signal and a right audio channel signal. Additionally, the systems and methods of the present disclosure provide for a wireless audio system where at least one of the speakers is configured to detect and demodulate wireless audio communication of a multiplexed audio signal occurring proximately, where the wireless audio communication is intended for another speaker.

According to one aspect of the present disclosure, a method is provided for streaming audio including receiving a multiplexed audio stream having at least two audio channel signals; demultiplexing the received audio stream into a left channel audio signal and a right channel audio signal; packaging each of the left channel audio signal and right channel audio signal with an indication for a respective recipient speaker; and

wirelessly transmitting the packaged left channel audio signal and packaged right channel audio signal.

According to another aspect of the present disclosure, a system is provided including a device including a demultiplexing module that receives a multiplexed audio stream having at least two audio channel signals and demultiplexes the received audio stream into a left channel audio signal and a right channel audio signal, a packaging module that packages each of the left channel audio signal and right channel audio signal with an indication for a respective recipient speaker; and a transceiver that wirelessly transmits the packaged left channel audio signal and packaged right channel audio signal; and left and right speakers, each speaker including a transceiver that receives the packaged left channel audio signal and packaged right channel audio signal and determines an address in a packet of each of the packaged left channel audio signal and packaged right channel audio signal; and a driver that plays the respective signal having an address that matches the address of the respective recipient speaker.

### BRIEF DESCRIPTION OF THE DRAWINGS

The above and other aspects, features, and advantages of the present disclosure will become more apparent in light of the detailed description when taken in conjunction with the accompanying drawings.

FIG. 1 is an exemplary system for wireless transmission of audio signals to multiple discrete speakers in accordance with the present disclosure;

FIG. 2 illustrates an exemplary speaker in accordance with the present disclosure;

FIG. 3 illustrates an exemplary method for wireless transmission of a left and right channel audio signal in accordance with the present disclosure;

FIG. 4 is an exemplary system for wireless transmission of audio signals to multiple discrete speakers in accordance with the present disclosure;

FIG. 5 is an exemplary system for wireless transmission of audio signals to a three way speaker system in accordance with the present disclosure;

FIG. 6 illustrates an exemplary method for creating a bass channel audio signal in accordance with the present disclosure;

FIG. 7 illustrates another exemplary system for wireless transmission of audio signals to multiple discrete speakers in accordance with the present disclosure;

FIG. 8 illustrates an exemplary speaker in accordance with the present disclosure; and

FIG. 9 illustrates another exemplary speaker in accordance with the present disclosure.

The images in the drawings are simplified for illustrative purposes and are not depicted to scale.

The appended drawings illustrate exemplary embodiments of the present disclosure and, as such, should not be considered as limiting the scope of the disclosure that may admit to other equally effective embodiments. Correspondingly, it has been contemplated that features or steps of one embodiment may beneficially be incorporated in other embodiments without further recitation.

### DESCRIPTION OF EMBODIMENTS

Embodiments of the present disclosure will be described herein below with reference to the accompanying drawings. In the following description, well-known functions or constructions are not described in detail to avoid obscuring the present disclosure in unnecessary detail. The word “exemplary” is used herein to mean “serving as an example, instance, or illustration.” Any configuration or design described herein as “exemplary” is not necessarily to be construed as preferred or advantageous over other configurations or designs. Herein, the phrase “coupled” is defined to mean directly connected to or indirectly connected with through one or more intermediate components. Such intermediate components may include both hardware and software based components.

It is further noted that, unless indicated otherwise, all functions described herein may be performed in either hardware or software, or some combination thereof. In one embodiment, however, the functions are performed by at least one processor, such as a computer or an electronic data processor, digital signal processor or embedded micro-controller, in accordance with code, such as computer program code, software, and/or integrated circuits that are coded to perform such functions, unless indicated otherwise.

It should be appreciated that the present disclosure can be implemented in numerous ways, including as a process, an apparatus, a system, a device, a method, or a computer readable medium such as a computer readable storage medium or a computer network where program instructions are sent over optical or electronic communication links.

It should be understood that the elements shown in the figures may be implemented in various forms of hardware, software or combinations thereof.

Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Almost all computers on the market today, such as an iPad™ device, Kindle™ device, Chromebook™ device, Surface™ device, etc., come with a built-in WiFi module for wireless connections using Internet protocol and IP addresses. The present disclosure provides for techniques and methods for using the built-in WiFi modules found in modern computing devices to establish a rich wireless audio system for use in multiple environments. For example, in one embodiment of the present disclosure, a computing device receives a multiplexed audio signal containing multiple audio channels and demultiplexes the signal and transmits separate demultiplexed signals to wireless speakers, where the separate wireless signals can be played by the individual wireless speakers. In another embodiment of the present disclosure, a computing device receives a multiplexed audio signal containing a left and a right audio signal and demultiplexes the signal and uses the left and right audio signals to create a bass signal for use with a three way sound system. In yet another embodiment of the present disclosure, a wireless speaker is configured to listen and intercept a wirelessly transmitted multiplexed signal and demultiplex the signal to play a predetermined audio channel.

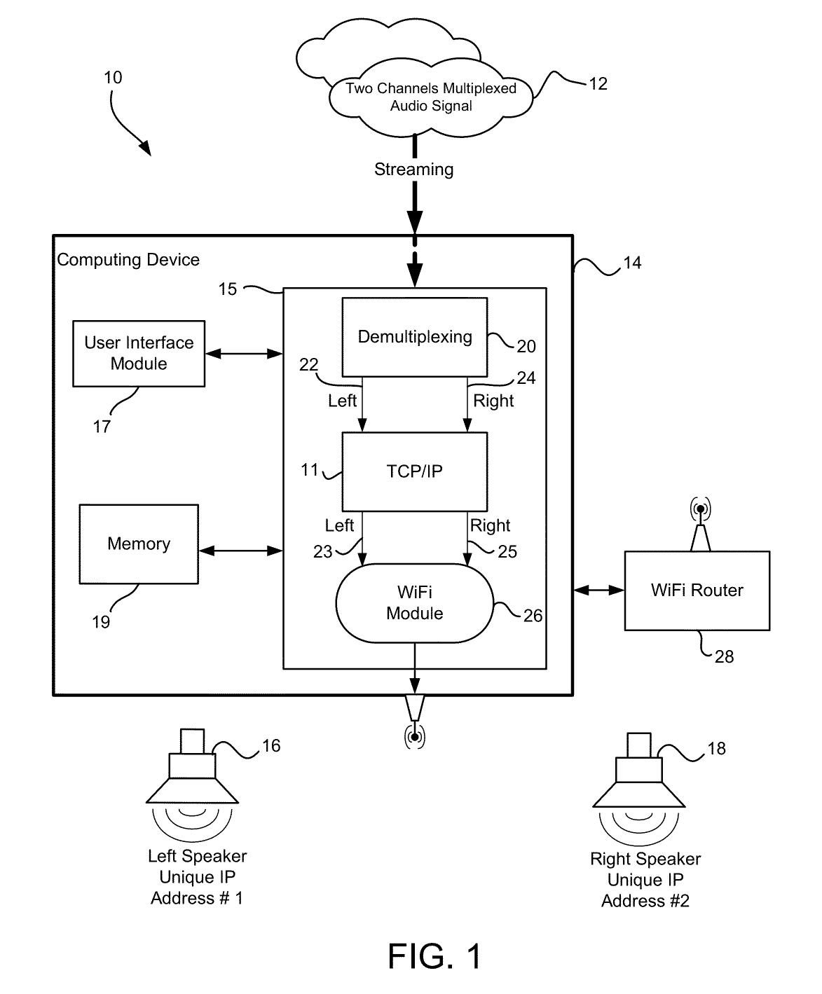

Referring to FIG. 1, an exemplary system 10 for wireless transmission of sound signals to multiple discrete speakers is illustrated. System 10 includes a computing device 14 coupled to the Internet 12, and, optionally, WiFi router 28. Furthermore, system 10 includes wireless speakers 16, 18, which can be coupled wirelessly to computing device 14 as will be described below. Computing device 14 further includes a user interface 17 and memory 19. Additionally computing device 14 includes at least one processor 15, where the at least one processor 15 includes demultiplexing module 20, TCP/IP or packaging module 11, and WiFi module 26. It is to be appreciated that in some embodiments one or more of the components shown in computing device 14 may be disposed outside computing device 14 and coupled to computing device 14 via one of various connection ports (i.e., USB, Ethernet, etc.). For example, memory 19 may be a separate component, such as a USB memory, coupled to computing device 14. Additionally, each of demultiplexing module 20, TCP/IP module 11 and WiFi module 26 may be separate hardware components or operating on separate processors.

When system 10 is in use, audio content is streamed from the Internet 12 to computing device 14. It is to be appreciated that in some embodiments the audio content may be received by WiFi module 26, where WiFi module 26 is configured act bidirectionally (i.e., send and receive audio signals). It is to be appreciated that audio content may be streamed to computing device 14 via other sources coupled to computing device 14 such as, but not limited to, a media server, CD player, or memory 19, etc. It is also to be appreciated that computing device 14 may be one of many computing devices capable of wireless communications, such as, but not limited to, an iPad™ device, Kindle™ device, Chromebook™ device, Surface™ device, laptop computer, mobile phone, etc. The audio content received by computing device 14 is then processed and wirelessly transmitted to discrete speakers, e.g., left speaker 16 and right speaker 18, as will be described in greater detail below.

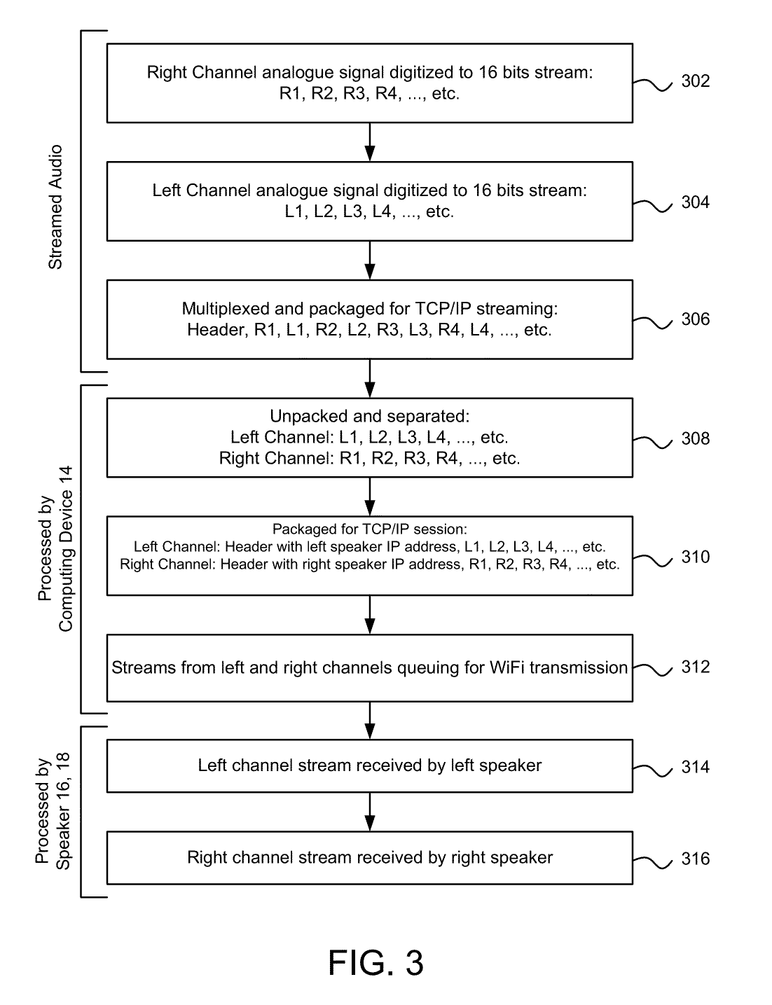

Demultiplexing module 20 is configured to receive (via Internet 12 or a memory 19 or any other source) audio signals of multiple channels that have been multiplexed into one single stream of data. For example, in FIG. 1, a two-channel multiplexed signal is being streamed via Internet 12 to computing device 14. Once the multiplexed audio stream is received by computing device 14, in some embodiments, the demultiplexing module 20 is configured to demultiplex the signal into multiple channels, such as left and right in stereo, or, left, center, right, left rear and right rear, in 5.1 audio format. In the embodiment shown in FIG. 1, demultiplexing module 20 is configured to demultiplex the incoming audio signal stream into multiple channel streams, namely, left channel 22 and right channel 24 in stereo, while preserving each stream's digital format, without converting the streams to an analogue signal, the details of which will be described below in relation to FIG. 3.

Computing device 14 is configured such that it may detect wireless speakers 16 and 18. In one embodiment, computing device 14 uses auto-discovery techniques to detect wireless speakers 16, 18 and establish communication of audio signals demultiplexed in demultiplexing module 20. For example, in FIG. 1, speakers 16 and 18 each include a built-in WiFI transceiver (not shown), which is given a unique identification code. In some embodiments, the identification code is a unique MAC address. In some embodiments, the MAC address may be comprised of a manufacturer's registered factory number plus the product serial number. In other embodiments, such as the embodiment shown in FIG. 1, the identification code is a unique IP address.

WiFi module 26 in computing device 14 is configured to scan and detect wireless speakers in the proximate WiFi environment. For example, in FIG. 1, left speaker 16 and right speaker 18 each are equipped with a unique IP address. WiFI module 26 in computing device 14 is configured to auto-discover speakers 16, 18 and record each speaker's unique IP address. After WiFi module 26 has discovered and recorded each speaker's IP address, computing device 14 is configured to allow a user to designate each speaker 16, 18 as an intended recipient speaker for a specific channel, for example, a right and a left channel. For example, after WiFi module 26 has discovered speakers 16, 18, a graphical user interface may be generated using user interface module 17 and the graphical user interface may be displayed on a display coupled to computing device 14 (e.g., the screen of a tablet or laptop or a separate monitor coupled to a desktop computer). The graphical user interface may inform a user that speaker 16 and 18 have been discovered and provide the user with an option to designate each speaker as a dedicated audio channel (e.g., right and left channels). It is to be appreciated that other known methods for auto-discovery of a client device are to be considered to be within the scope of the present disclosure.

After speakers 16 and 18 have been designated to receive audio of a specific channel, for example, in FIG. 1, speaker 16 has been designated as a left audio channel and speaker 18 has been designated as a right audio channel, a TCP/IP session may be initiated to transmit any demultiplexed audio signals to speakers 16 and 18. For example, computing device 14 may receive a multiplexed signal via Internet 12, where the multiplexed signal includes two channels: a right channel and a left channel.

In demultiplexing module 20, the multiplexed signal will be separated into left audio signal 22 and right audio signal 24. Left audio signal 22 and right audio signal 24 are then provided to TCP/IP module 11, where the signals 22 and 24 are converted into IP packets for wireless transmission. TCP/IP module 11 will convert left audio signal 22 to a left audio packet stream 23 and right audio signal 24 to right audio packet stream 25. TCP/IP module 11 will include in the header of each packet in left audio packet stream 23 the unique IP address (or any other identification code) of speaker 16, which has been designated as the intended recipient speaker to play the left audio. Similarly, TCP/IP module 11 will include in the header of each packet in right audio packet stream 25 the unique IP address (or any other identification code) of speaker 18, which has been designated as the intended recipient speaker to play the right audio. Audio packet streams 23 and 25 are then provided to WiFI module 26 where the packet streams 23, 25 are transmitted to speaker 16 and 18 over a WiFi environment. It is to be appreciated that in certain embodiments, if the computing device 14 does not support dual WiFi traffic between the computing device 14 and speakers 16, 18, a WiFi router 28 may be coupled to the computing device 14 to simultaneously transmit audio packet streams 23 and 25 over a WiFi environment.

In the case of stereo transmission, there are two ports open, one for transmission of left channel signal to connect with left speaker 16, and one for right channel to connect with right speaker 18. Once a TCP/IP session is initiated by the computing device 14, a port number is assigned to the software program(s) responsible for sending, receiving and processing of the data transmitted and received. This port number ties and bonds the data with the program that handles the data.

Speakers 16 and 18 are configured to determine, based on the headers in the packets of any audio packet streams received, whether the audio packet stream should be recorded and/or played. For example, speaker 16 is configured to detect audio packet streams that include a header with the unique identification code (e.g., the unique IP address of speaker 16) of speaker 16. If speaker 16 determines that the audio packet stream being received contains a header with the unique identification code of speaker 16, speaker 16 will record the audio packet stream and play the audio. Similarly, speaker 18 is configured to detect audio packet streams that include a header with the unique identification code (e.g., the unique IP address of speaker 18) of speaker 18. If speaker 18 determines that the audio packet stream being received contains a header with the unique identification code of speaker 18, speaker 18 will record the audio packet stream and play the audio. Both speaker 16 and 18 are configured to reject audio packet streams that contain headers that do not match with their own unique identification codes. For example, if speaker 16 receives audio packet stream 25, speaker 16 will determine that the headers in the packets of audio packet stream 25 each contain an identification code that does not match the unique identification code of speaker 16, and therefore, speaker 16 will not record or play audio packet stream 25. In this way, speaker 16 is configured to record and play audio received exclusively from audio packet stream 23 and speaker 18 is configured to record and play audio received exclusively from audio packet stream 25.

The system of the present disclosure as described above will allow the speakers 16, 18 to be placed far apart from each other and from the computing device 14, since there is no need for a signal cable to run from the computing device 14 to the speakers 16, 18, nor from speaker 16 to speaker 18. The system of the present disclosure with speakers placed far apart can result in a big and wide sound stage, making the stereo playback more vivid and lively. It is to be appreciated that although only two speakers are shown in FIG. 1, that the system 10 of FIG. 1 can include many more wireless speakers in accordance with the present disclosure as will be described below.

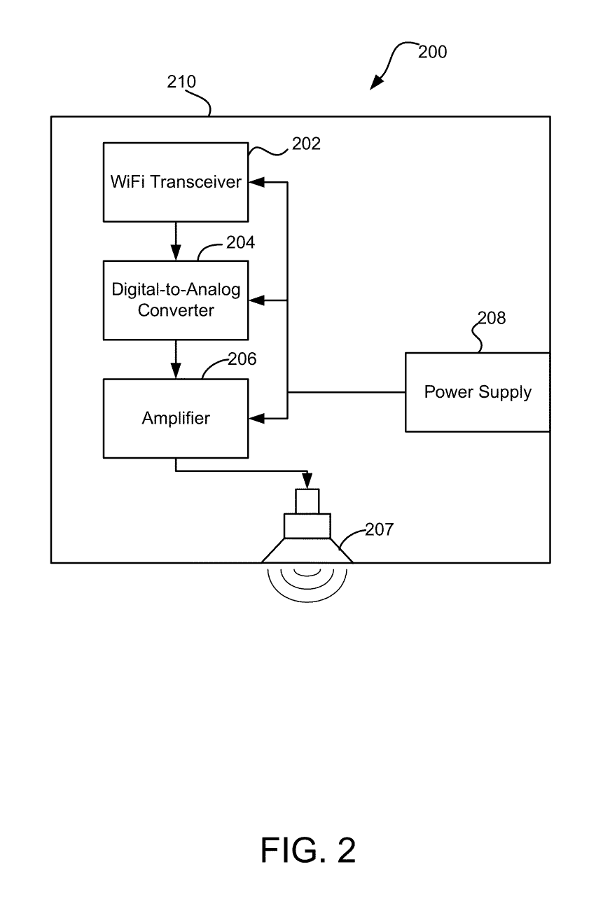

Referring to FIG. 2, an exemplary speaker 100 in accordance with the teachings of the present disclosure is illustrated. It is to be appreciated that speaker 100 is a more detailed illustration of some of the internal components of speakers 16 and 18 described above in reference to FIG. 1. The speaker 200, includes a WiFi transceiver 202, a built in a digital-to-analog (D/A) converter 204, an amplifier 206 coupled to a speaker driver 207, and either a battery pack or a power supply 208 and power cable for powering each of the components (not shown). WiFi transceiver 202 is configured to receive audio packet streams sent over a WiFi network (for example, from computing device 14) and, as described above in reference to speaker 16 and 18, determine based on the identification code in the header of the stream if the audio packet stream should be recorded and/or played. If the headers in the packets of the audio packet stream received by WiFi transceiver 202 include an identification code, such as a unique IP address, that matches the identification code stored in WiFi transceiver 202, then WiFi transceiver 202 will record the audio packet stream and provide the audio packet stream to D/A convert 204, where the received audio packet stream is converted from a digital signal to an audio signal. The converted audio signal is then provided to amplifier 206 to be amplified and then to speaker driver 207 to be played.

It is to be appreciated that the components shown in FIG. 2 are disposed in an appropriate housing or enclosure 210. Exemplary drivers and speakers are shown and described in commonly owned U.S. application Ser. Nos. 12/657,686, 13/023,792 and 13/593,736, the contents of all of which are hereby incorporated by reference. It is to be appreciated that any of the speakers shown and described in U.S. application Ser. Nos. 12/657,686, 13/023,792 and 13/593,736 may include the circuitry shown in FIG. 2 to achieve the teachings of the present disclosure.

Referring to FIG. 3, a process flow is provided for using system 10 for wireless transmission of sound signals to speakers 16 and 18 in accordance with the present disclosure. It is to be appreciated that speakers 16 and 18 each contain similar components as speaker 100. Initially, in step 302, a right channel analogue signal is digitized to a 16 bit stream, e.g., R1, R2, R3, R4, . . . , etc. Additionally, in step 304, a left channel analogue signal is digitized to a 16 bit stream, e.g., L1, L2, L3, L4, . . . , etc. In step 306, the digitized left and right channel bit streams are multiplexed and packaged for TCP/IP streaming: (Header, R1, L1, R2, L2, R3, L3, R4, L4, . . . , etc.). For example, in a WAV file, the left & right channels are alternated: for a 16-bit file, the first two bytes (following the header) are the left channel, and the next two bytes are the right, then two left-bytes. , etc. Multi-channel files are the same, with a longer repeated sequence. In one embodiment, steps 302, 304, and 306 are processed by an audio source and provided over a network, e.g., the Internet 12. In another embodiment, steps 302, 304, and 306 are processed in computing device 14, where computing device 14 has right and left analogue signals stored in memory 19 included in computing device 14.

At step 308, the computing device 14 receives the streamed audio and the signals are unpacked and separated by the demultiplexing module 20 in left channel audio stream 22 and right channel audio stream 24:

Left channel: L1, L2, L3, L4 . . . , etc.
Right channel: R1, R2, R3, R4, . . . etc.

At step 310, the demultiplexed signals 22 and 24 are provided to TCP/IP module 11 and processed by a protocol stack in TCP/IP module 11 and packaged for a TCP/IP session, where signal 22 is packaged to left audio packet stream 23 and signal 24 is packaged to right audio packet stream 25. As stated above, WiFi module 26 is configured to detect and record the IP addresses of speakers 16 and 18 so that each speaker can be designated to receive a specific audio signal (e.g., speaker 16 is designated as a speaker to receive a left audio signal and speaker 18 is designated as a speaker to receive a fight audio signal). Therefore, when demultiplexed signals 22 and 24 are provided to TCP/IP module 11, TCP/IP module 11 will place the IP address of speaker 16 in the header of each packet in left audio packet stream 23 and TCP/IP module 11 will place IP address of speaker 18 in the header of each packet in right audio packet stream 25:

Left channel (header with left speaker 16 IP address, L1, L2, L3, L4, . . . etc.)
Right channel (header with right speaker 18 IP address, R1, R2, R3, R4, . . . ,etc.)

At step 312, the packaged signals 23 and 25 are transmitted to the WiFi module 26, which streams the left and right channels queuing for WiFi transmission. Lastly, in step 314, the left audio packet stream 23 is received by a WiFi transceiver 202 in left speaker 16 and, in step 316, the right audio packet stream 25 is received by a WiFi transceiver 202 in right speaker 18. The received digital streams are then converted into analog streams by digital-to-analog converters 204 in speakers 16, 18, amplified in an amplifier 206, and played at the respective speaker.

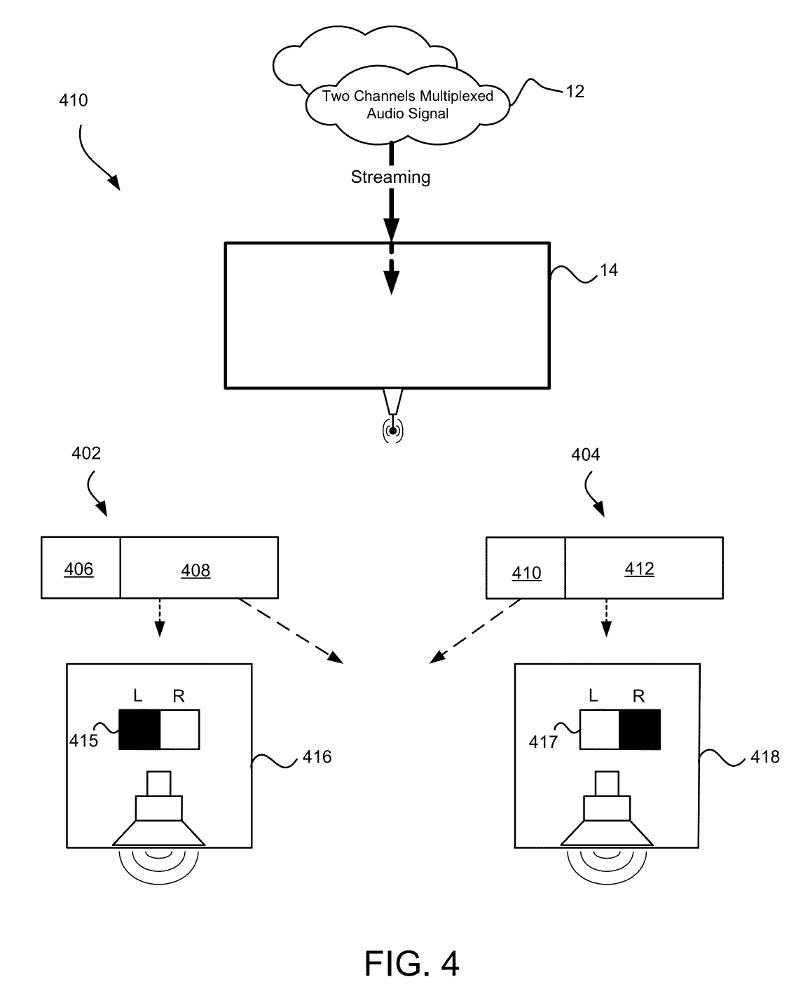

It is to be appreciated that although system 10 utilizes auto-discovery techniques to designate which wireless speaker is intended to receive and play a specific audio signal, system 10 may be altered to utilize other techniques to designate which wireless speaker is intended to receive and play a specific audio signal. For example, in another embodiment, system 10 may be configured such that speakers 16 and 18 may be manually set via a switch on speakers 16 and 18 to receive and play the wireless audio transmission of a specific channel. Turing to FIG. 4, a system 410 for transmitting audio signals to wireless speakers is shown in accordance with the present disclosure.

System 410 includes computing device 14 coupled to Internet 12, where similar to system 10 in FIG. 1, computing device 14 is receiving a multiplexed audio signal containing a left audio channel signal and a right audio channel signal. System 410 also includes speaker 416 and speaker 418. It is to be appreciated that computing device 14 in FIG. 4 is the same as computing device 14 shown in FIG. 1. As stated above, computing device 14 is configured to demultiplex the received multiplex signal into a left audio signal and a right audio signal. The left audio signal and the right audio signal are then provided to TCP/IP module 11 and converted into a left audio packet stream and right audio packet stream. The left audio packet stream contains left audio IP packets 402, where each left audio IP packet 402 contains a header 406 and a body 408. Similarly, the right audio packet stream contains right audio IP packets 404, where each right audio IP packet 404 contains header 410 and body 412. It is to be appreciated that the body 408 of each left audio IP packet 402 will contain a portion of the demultiplexed left audio signal (i.e., L1, L2, L3, . . . , etc.) and body 412 of each right audio IP packet 404 will contain a portion of the demultiplexed right audio signal (i.e., L1, L2, L3, . . . , etc.).

In contrast to system 10, in system 410, headers 406 and 410 in IP packets 402 and 404, respectively, will contain a designation indicating whether the packet is intended to be a left speaker packet or a right speaker packet. For example, a packet intended for a left speaker may include combination of 1's and 1's representing “left speaker” or simply “L” in the header of the packet to indicate the packet is intended for the left speaker. Similarly, a right packet intended for a right speaker may include a combination of 1's and 0's representing “right speaker” or simply “R” in the header of the packet to indicate that packet is intended for the right speaker. Therefore, referring to FIG. 4, header 406 will include an indication that packet 402 is intended for transmission to a left speaker and header 410 will include an indication that packet 404 is intended for transmission to a right speaker. Additionally, the indication may be a single bit in the header or a single bit in each channel designation.

It is to be appreciated that speakers 415 and 416 each include similar components to those included in speakers 16 and 18. However, speaker 415 and 416 also each include a switch, where speaker 416 includes switch 415 and speaker 418 includes switch 417. Switches 415 and 417 may each be positioned by a user toward the left (designated by the letter L) or toward the right (designated by the letter R). The speakers in system 410 are configured such that when the switch on a specific speaker is disposed toward the left, the WiFi transceiver in the speaker is configured to record and play audio IP packets with headers including an indication that the IP packet is intended for transmission to the left speaker. Similarly, the speakers in system 410 are configured such that when the switch on a specific speaker is disposed toward the right, the WiFi transceiver in the speaker is configured to record and play audio IP packets with headers including an indication that the IP packet is intended for transmission to the right speaker. Therefore, as seen in FIG. 4, if switch 415 on speaker 416 is disposed toward the left, the WiFi transceiver in speaker 416 will be configured such that the WiFi transceiver in speaker 416 will only record and play left audio IP packets 402 that are received. Similarly, if switch 417 on speaker 418 is disposed toward the right, the WiFi transceiver in speaker 418 will be configured such that the WiFi transceiver in speaker 418 will only record and play right audio IP packets 404 that are received. In this way, when left and right audio IP packets 402 and 404 are transmitted by communication device 14 over a WiFi network to speakers 416 and 418, speaker 416 will only play the left audio signal and speaker 418 will only play the right audio signal.

It is to be appreciated in other embodiments the switches disposed in the wireless speakers of system 410 may include more than two positions so that system 410 may be configured to support more than two speakers. For example, the switches may include 5, 6, or 7 positions to support various surround sound configurations.

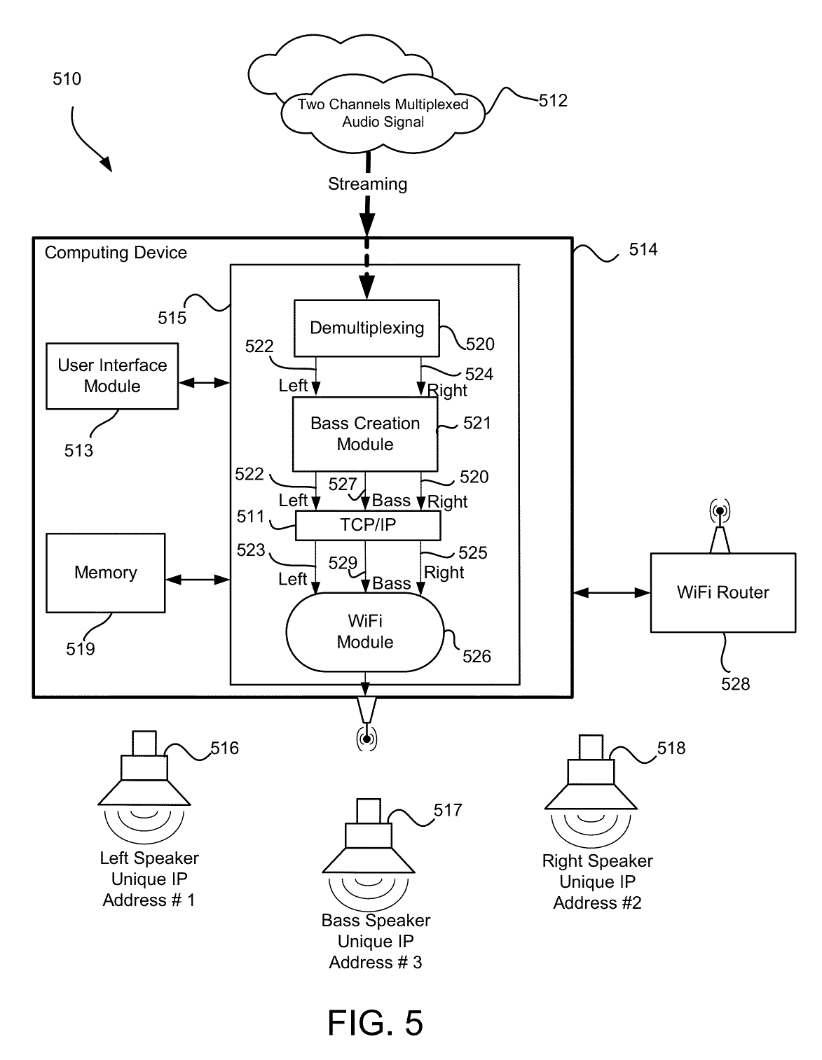

It is to be appreciated that although systems 10 and 410 are shown as including only two speakers, systems 10 and 410 may be configured for use with as many speakers as desired. For example, systems 10 and 410 may be configured for use with a three way speaker system comprised of left channel, right channel, and bass unit speakers. Such a system would be able to provide enhanced bass performance through the bass unit speaker, while preserving the stereo sound stage through the left channel and right channel speakers. However, most multiplexed audio streaming only contains left and right channel audio data streams. Therefore, in another embodiment of the present disclosure, a computing device may include a bass creation module configured to receive a multiplexed audio stream containing only the left and right audio channels and to create a separate bass audio stream using the data from the left and right audio channels. In this way, although a multiplexed signal containing only a left and right channel is received, a three way speaker system may still be used. This embodiment will be described below in relation to FIG. 5.

Turning to FIG. 5, an exemplary system 510 for wireless transmission of sound signals in a three way speaker system is shown in accordance with the present disclosure. System 510 includes a two channel (i.e., right and left channel) multiplexed audio signal that is streamed via Internet 512 to computing device 514. Also included in system 510 is WiFi router 528, speaker 516, speaker 517, and speaker 518. It is to be appreciated that speakers 516, 517, and 518 may be designated as left, right, and/or bass speakers either using the auto-discovery technique described above in relation to system 10, or by manual disposing a switch on each speaker (where the switch has three positions: left, middle for bass, and right) to designate that speaker as a left, right, or bass speaker as described above in relation to system 410.

Similar to computing device 14 in systems 10 and 410, computing device 514 in system 510 includes demultiplexing module 520 that is configured to receive the multiplexed audio signal via Internet 514 and demultiplex the audio signal into left channel audio signal 522 and right channel audio signal 524. Left channel audio signal 522 and right channel audio signal 524 are provided to a bass creation module 521. Bass creation module 521 is configured to receive left channel audio signal 522 and right channel audio signal 524 to create a bass channel audio signal 527.

After bass creation module 521 has created bass channel audio signal 527, bass creation module 521 will provide left channel audio signal 522, bass channel audio signal 527, and right channel audio signal 524 to TCP/IP module 511 where signals 522, 527, and 524 will be packaged into IP packet streams in a similar manner as described in previous embodiments. Specifically TCP/IP module 511 will convert left channel audio signal 522 into left audio IP packet stream 523, TCP/IP module 511 will convert bass channel audio signal 527 into bass audio IP packet stream 529, and TCP/IP module 511 will convert right channel audio signal 524 into right audio IP packet stream 525. IP packets stream 523, 529, and 525 will then be provided to WiFi module 526, where WiFi module 526 is configured to wirelessly transmit left audio IP packet stream 523 to left speaker 516, bass audio IP packet stream 529 to bass speaker 517, and right audio IP packet stream 525 to right speaker 518.

It is to be appreciated that if computing device 514 does not support multi-WiFi traffic between computing device 514 and speakers 516, 517, and 518, a WiFi router 528 may be coupled to computing device 514 to transmit IP packet stream 523, 529, and 525.

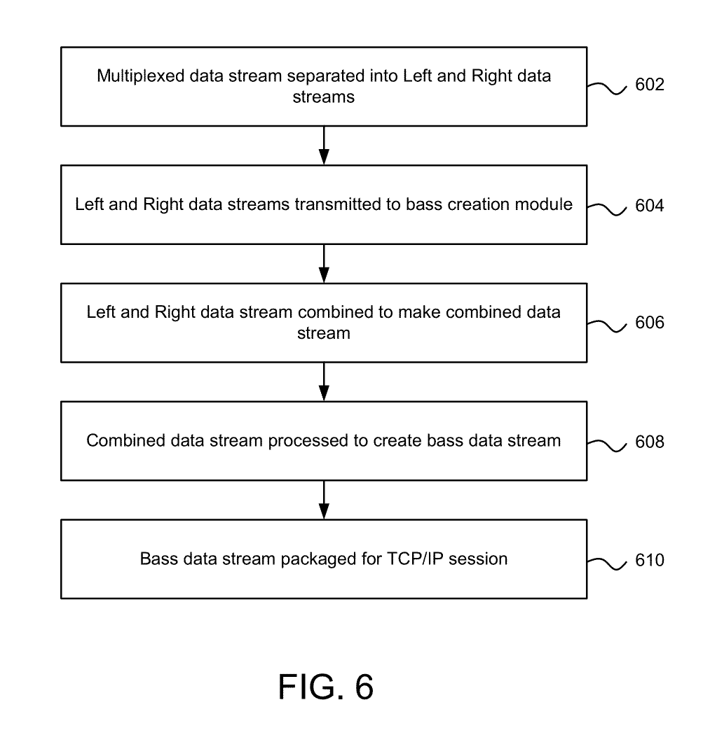

Turning now to FIG. 6, an exemplary method for creating a bass channel data stream in accordance with the present disclosure is shown. In step 602, computing device 514 receives a multiplexed audio signal via Internet 512 and demultiplexes the signal in demultiplexing module 520 into a left audio channel signal 522 and a right audio channel signal 524, where left audio channel signal 522 may be represented as L1, L2, L3, L4, . . . , etc. and right audio channel signal stream 524 may be represented as R1, R2, R3, R4, . . . , etc.

In step 604, left audio channel signal 522 and right audio channel signal 524 are provided to bass creation module 521. In step 606, bass creation module 521 will combine left and right audio channel signals 522, 524 by adding each L and R data bit and dividing the result by 2 to produce a combined data stream, where the combined data stream may be represented by C1, C2, C3, C4, . . . , etc:

C1=(L1+R1)/2

C2=(L2+R2)/2

C3=(L3+R3)/2

C4=. . . etc.

In step 608, the combined data stream C1, C2, C3, C4, . . . , etc. is then processed in bass creation module 421 using Fourier Series Digital Transformation to truncate the combined data stream of the high frequency components, and recombined to make a new audio channel signal (i.e., the bass audio channel signal 525) containing only the low frequency audio data, where the bass audio channel signal 525 may be represented by B1, B2, B3, B4, . . . , etc. It is to be appreciated that the Fourier Series Digital Transformation expands the combined data stream into a frequency based infinite series where a frequency cut off point can be chosen such that all series above or below the cut off point may be dropped or neglected. The remaining series that have not been neglected are then combined again to form an artificial signal (i.e., the bass audio channel signal 525).

In step 610, the low frequency data stream B1, B2, B3, B4, . . . , etc., referred to as the bass audio channel signal 525, is then packaged (via TCP/IP module 511) to form IP packets with the bass speaker's IP address in the header (or alternatively, with an indication that the packet is intended for a bass speaker), and provided to WiFi module 526 to be transmitted over WiFi to bass speaker 517.

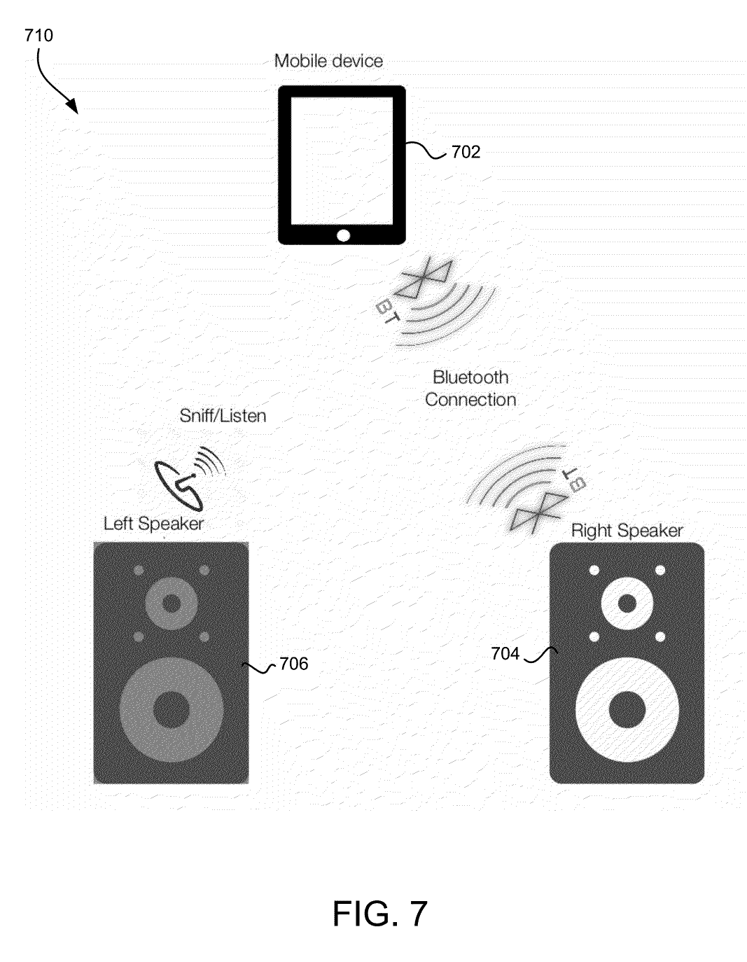

It is to be appreciated that in some embodiments systems 10, 410, and 510 may be configured such that instead of demultiplexing the multiplexed audio signals in computing device 14/514, computing device 14/514 transmits the multiplexed audio signals to the wireless speakers where they are demultiplexed at each individual wireless speaker. It is to be further appreciated that in other embodiments systems 10, 410, and 510 may be configured such that computing device 14/514 provides multiplexed digital audio transmission to only one of the wireless speakers in system 10/410/510. While the multiplexed digital audio transmission is occurring, the other wireless speakers in system 10/410/510 are configured to detect the communication and demultiplex the digital audio signal and play the audio channel intended for that specific speaker. In this embodiment, multiple speakers may be used to play wirelessly transmitted audio signals even though computing device 14/514 is only configured to transmit the wireless audio signal to one of the speakers. Below this embodiment will be described in greater detail in accordance with the present disclosure in relation to FIG. 7.

FIG. 7 illustrates an exemplary system 710 for wireless transmission of sound signals to multiple discrete speakers in accordance with the present disclosure. System 710 includes mobile device 702, speaker 704 and speaker 706. It is to be appreciated that mobile device 702 may be any number of mobile computing devices such as, but not limited to, a smartphone, laptop, tablet, etc. For example, in FIG. 7, mobile device 702 is represented as a tablet computer.

In this embodiment, a mobile device 702 receives multiplexed audio streaming data and re-transmits it via a Bluetooth or a WiFi connection to a speaker 704, which is equipped with the corresponding transceiver, i.e., a Bluetooth or WiFi transceiver. Speaker 704 receives the streaming audio data, decodes it, demultiplexes it, and plays one of the de-multiplexed audio channels, for example, a right channel of a stereo audio signal. It is to be appreciated that speaker 704 may be designated as the speaker intended to play the right audio channel signal either via the auto-discovery method described in previous embodiments.

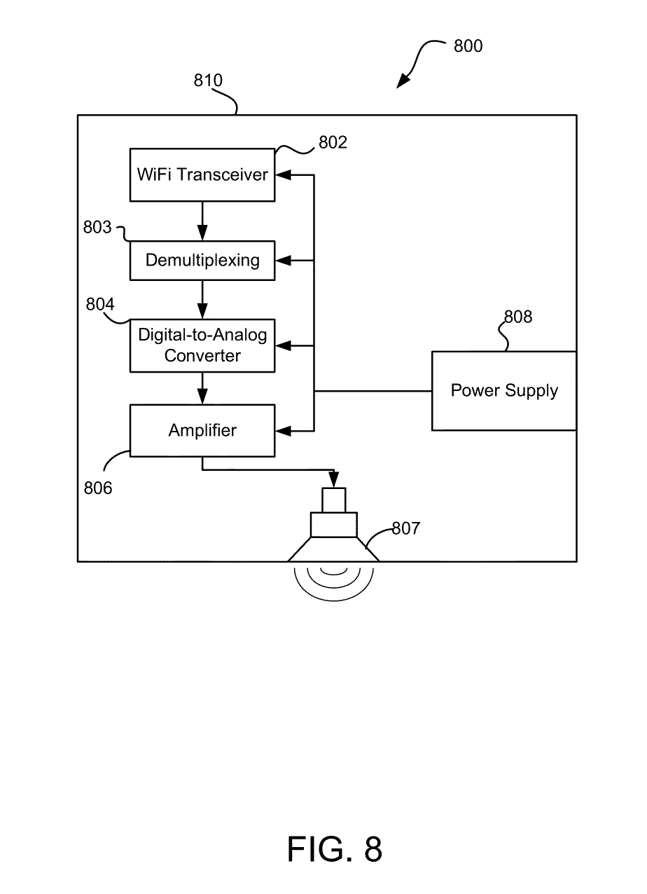

For example, turning to FIG. 8, an exemplary speaker 800 is shown in accordance with the present disclosure. It is to be appreciated that speaker 700 is a more detailed illustration of some of the internal components of speaker 704 from FIG.

7.

The speaker 800, includes a WiFi or Bluetooth transceiver 802, a demultiplexing module 803, a digital-to-analog (D/A) converter 804, an amplifier 806 coupled to a speaker driver 807, and either a battery pack or a power supply 808 and power cable for powering each of the components (not shown). It is to be appreciated that the components shown in FIG. 8 are disposed in an appropriate housing or enclosure 810. It is also to be appreciated that demultiplexing module 803 has similar capabilities to demultiplexing module 20, where demultiplexing module 803 is capable of demultiplexing a multiplexed audio signal. In addition, demultiplexing module 803 is configured to determine which channel among the channels in the multiplexed signal should be played.

For example, when WiFi transceiver 802 receives a multiplexed audio signal from an audio source, for example, mobile device 702, WiFi transceiver 802 will provide the multiplexed audio signal to demultiplexing module 803. Demultiplexing module 803 will demultiplex the multiplexed audio signal and determine which demultiplexed audio signal should be played, for example, demultiplexing module 803 may be configured as a right speaker (when mobile device 702 and speaker 704/800 have discovered each other during auto-discovery) and therefore determine that only the right channel audio signal should be played. Whichever demultiplexed digital audio signal has been determined as the signal that should be played will be provided to D/A converter 804 where the signal will be converted from a digital signal to an analogue signal. The converted analogue signal will then be provided to amplifier 806 to be amplified. The amplified signal will then be provided to speaker driver 807 to be played.

Returning to FIG. 7, a second speaker 706, separate and independent from the above described first speaker 704/800, is equipped with a sniff/listen device. This sniff/listen device in speaker 706 is designed to sniff the radio frequency channels in the Bluetooth and WiFi radio frequency spectrum to uncover and identify the radio frequency channel being used for transmission of the streaming audio data by the computer 702 and the first speaker 704. Once the radio frequency channel is identified, it is locked and listened in. Speaker 706 will then copy the header section of the digital message packets in the audio data and decode the header to read any identifying information such as, but not limited to an IP address or a MAC address for the device intended to receive the audio data. Speaker 706 will then compare the identification information found in the header of the packet with pre-stored identification information stored in memory of speaker 706 to determine if the audio data is intended for speaker 704. If speaker 706 determines that the audio data is not intended for speaker 704, then speaker 706 will disregard the audio data and discontinue listening. However, if speaker 706 determines that the audio data is intended for speaker 704, the audio streaming data in transmission in the audio data is then copied, decoded, and de-multiplexed by speaker 706, and speaker 706 will play a different audio channel than is being played by speaker 704, for example speaker 706 will play the left audio channel.

It is to be appreciated that similar to speaker 416 and 418, speaker 706 includes a switch allowing a user to manual select the audio channel that speaker 706 is intended to play. For example, in FIG. 7 speaker 706 has been selected by a user to be a left speaker, and therefore only play the left audio data.

Since the sniff/listen device in the second speaker 706 is a radio silent “listener”, it does not interfere with the communication session that the computer 702 and speaker 704 is holding, whether it is in Bluetooth or WiFi. Therefore, the above described embodiment illustrated in FIG. 7 achieves multichannel wireless audio transmission while only requiring a computer to be configured to transmit audio to one speaker instead of multiple speakers. It is to be appreciated that system 710 may be configured for use with multiple speakers that have the listen/sniff capabilities of speaker 706. For example, multiple additional listen/sniff speakers may be included in system 710 to achieve a surround sound set up. Furthermore, it is to be appreciated that in some embodiments system 710 includes a second listen/sniff speaker that further includes a bass creation module, such as bass creation module 521 described above. In this embodiment, the second listen/sniff speaker can be designated as a bass speaker via a switch (as described above in relation to FIG. 4) and can receive a multiplexed audio signal containing only and left and a right channel, and demultiplex the signal into a left audio signal and a right audio signal and the bass creation module in the listen/sniff speaker can create a bass audio signal using the left and right demultiplexed audio signal. In this way, system 702 can be configured to achieve a three way speaker system even though mobile device 702 is only configured to send audio data to speaker 704.

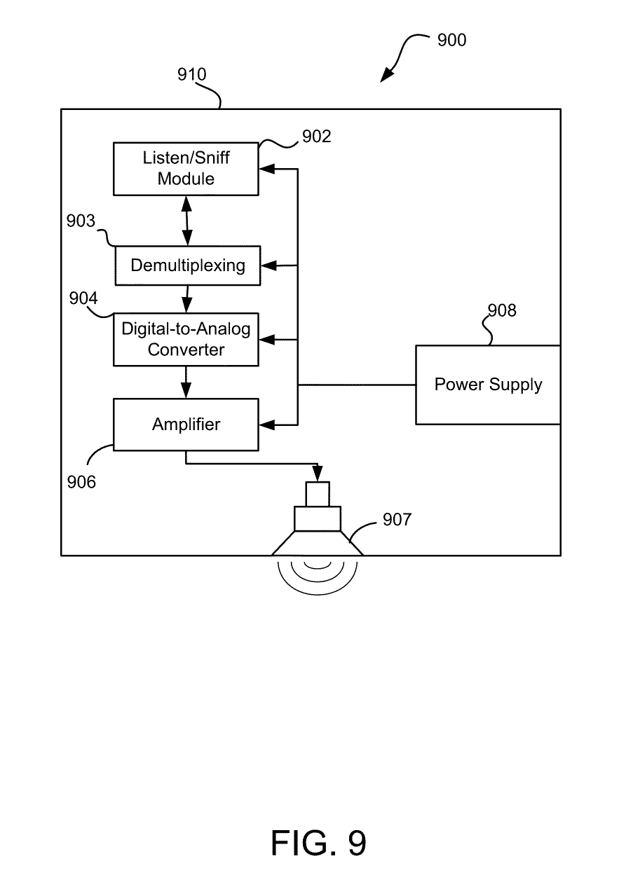

Turning to FIG. 9 an exemplary speaker 900 configured to “sniff” or “listen” for wireless audio transmissions is shown in accordance with the present disclosure. It is to be appreciated that speaker 900 is a more detailed illustration of some of the components of speaker 706. Speaker 900 includes a sniff/listen module 902, a demultiplexing module 903, a digital-to-analog (D/A) converter 904, an amplifier 906 coupled to a speaker driver 907, and either a battery pack or a power supply 908 and power cable for powering each of the components (not shown). It is to be appreciated that the components shown in FIG. 9 are disposed in an appropriate housing or enclosure 910. It is also to be appreciated that demultiplexing module 903 has similar capabilities to demultiplexing module 20 and 803, where demultiplexing module 903 is capable of demultiplexing a multiplexed audio signal. In addition, demultiplexing module 903 is configured to determine which channel among the channels in the multiplexed signal should be played.

For example, as stated above in reference to FIGS. 7 and 8, a mobile device 702 may wirelessly transmit a multiplexed audio signal to a speaker 704/800, where mobile device 702 and speaker 704/800 have discovered each other in a data sharing session. During this communication, listen/sniff module 902 in speaker 706/900 is configured to listen for wireless communications that are occurring, as described above. If listen/sniff module 902 detects a wireless communication occurring, the listen/sniff module 902 will copy the identifying information in the header of the information packets in the wireless communication to determine if the communication is meant for speaker 704/800. Listen/sniff module 902 will then compare the identifying information found in the information packet with identifying information stored in memory to determine if the communication is meant for speaker 704/800. If the communication is meant for speaker 704/900, listen/sniff module 902 will copy the streaming multiplexed audio signal being provided to speaker 704/800 and provide the multiplexed audio to demultiplexing module 903.

Demultiplexing module 903 will demultiplex the multiplexed audio signal and determine which demultiplexed audio signal should be played, for example, demultiplexing module 903 may be configured as a left speaker and therefore determine that only the left channel audio signal should be played. Whichever demultiplexed digital audio signal has been determined as the signal that should be played will be provided to D/A converter 904 where the signal will be converted from a digital signal to an analogue signal. The converted analogue signal will then be provided to amplifier 906 to be amplified. The amplified signal will then be provided to speaker driver 907 to be played.

It is to be appreciated that the various features shown and described are interchangeable, that is a feature shown in one embodiment may be incorporated into another embodiment.

While non-limiting embodiments are disclosed herein, many variations are possible which remain within the concept and scope of the present disclosure. Such variations would become clear to one of ordinary skill in the art after inspection of the specification, drawings and claims herein. The present disclosure therefore is not to be restricted except within the spirit and scope of the appended claims.

Furthermore, although the foregoing text sets forth a detailed description of numerous embodiments, it should be understood that the legal scope of the present disclosure is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A method for streaming audio comprising:
receiving a multiplexed audio stream having at least two audio channel signals;
demultiplexing the received audio stream into a left channel audio signal and a right channel audio signal;
packaging each of the left channel audio signal and right channel audio signal with an indication for a respective recipient speaker; and
wirelessly transmitting the packaged left channel audio signal and packaged right channel audio signal.

2. The method of claim 1, wherein the indication for a respective recipient speaker is an address of the recipient speaker.

3. The method of claim 2, further comprising:
receiving the packaged left channel audio signal and packaged right channel audio signal at respective recipient speaker;
determining an address in a packet of each of the packaged left channel audio signal and packaged right channel audio signal; and
playing the respective signal having an address that matches the address of the respective recipient speaker.

4. The method of claim 1, wherein the indication for a respective recipient speaker includes a designated left or right channel.

5. The method of claim 1, wherein the packaging step includes creating at least one packet for each of the left channel audio signal and right channel audio signal.

6. The method of claim 5, wherein the indication for a respective recipient speaker includes a designation of a left or right channel inserted in a header of the at least one packet.

7. The method of claim 6, further comprising:
designating the respective recipient speaker as a left or right channel speaker;
receiving the packaged left channel audio signal and packaged right channel audio signal at the respective recipient speaker;
determining the indication in a packet of each of the packaged left channel audio signal and packaged right channel audio signal; and
playing the respective signal having the indication that matches the designated channel of the respective recipient speaker.

8. The method of claim 1, further comprising:
combining the left channel audio signal and the right channel audio signal into a third audio signal;
transforming the third audio signal into a bass audio signal; and
wirelessly transmitting the bass audio signal.

9. The method of claim 8, wherein the transforming is performed by a Fourier Series Digital Transform.

10. A system comprising:
a device comprising:
a demultiplexing module that receives a multiplexed audio stream having at least two audio channel signals and demultiplexes the received audio stream into a left channel audio signal and a right channel audio signal,
a packaging module that packages each of the left channel audio signal and right channel audio signal with an indication for a respective recipient speaker; and
a transceiver that wirelessly transmits the packaged left channel audio signal and packaged right channel audio signal; and
at least left and right speakers, each speaker comprising:
a transceiver that receives the packaged left channel audio signal and packaged right channel audio signal and determines an address in a packet of each of the packaged left channel audio signal and packaged right channel audio signal; and
a driver that plays the respective signal having an address that matches the address of the respective recipient speaker.
